(19) United States
(12) Patent Application Publication
(10) Pub. No.: US 2016/0295813 A1
(43) Pub. Date: Oct. 13, 2016

(54) Bush Trimmings Catcher

(71) Applicant: Pamela A. Schvey, Naples, FL (US)

(72) Inventor: Pamela A. Schvey, Naples, FL (US)

(21) Appl. No.: 14/524,200

(22) Filed: Oct. 27, 2014

(51) Int. Cl. A01G 13/02; A01D 46/26

(52) U.S. Cl. CPC A01G 13/0287; A01D 46/26; A01G 13/0268; A01D 2046/262; A01G 2013/0218

(57) ABSTRACT

The inventive concept is directed toward a system for collecting trimmings that is used and placed under bushes to be trimmed. The system consists of a sheet to be placed under the bush. The sheet has a cut starting at an edge of the sheet and is directed toward the center of the sheet. At the center of the sheet, a circle is formed which will surround the trunk of the bush when the sheet is installed. The edges of the cut are surrounded by a border or tape including the circle to prevent the edges from fraying and to identify the opening. The border tape adheres to both sides of the sheet. The outer corners of the cut at the outer edge are are closed by a closing system.

### BACKGROUND OF THE INVENTION

A bush trimmings catcher is used to collect trimmings falling to the ground onto a catcher that is removable together with trimmings and the trimmings can easily be disposed of. There are known trimmings catchers such as the catcher disclosed in Design Patent No. 408,233. It is basically the same as the one disclosed in this application. But there are quite a few elements disclosed in this application that are not present in the Design Patent. Another trimmings catcher is disclosed in U.S. Pat. No. 5,580,635 that is disclosed as a collection tarpaulin. It discloses a slit ending in a center of the collector including a circular opening. But the structure is quite different from the structure at hand.

### BRIEF DESCRIPTION OF THE INVENTION

The inventive concept is directed toward a sheet of material of durable quality. It can be of a circular, rectangular or square configuration. A slit emanating from an edge of the sheet ends in the middle of the sheet in the form of a circle. To enhance the durability of the cut edges, a border tape is used to surround the edges to reinforce the same. The outer edges of the slit are provided with means for closing the same. This prevents the sheet from blowing up and away in case of wind bursts. It also prevents any trimmings from dropping off the sheet once it is filled and being transported to a disposal site. In addition, the outer ends of the slit are each provided with a string and a weight is attached at the end of each string. This aids in the installation of sheet under a bush. There are occasions when a bush to be trimmed is rather wide or close to the ground, whereby it is difficult to install the sheet under the bush for its intended purpose. In this case, each string can be thrown to the other side of the bush, because of its weight and on each side of the trunk of the bush. It is merely a task to grab each end of the strings lying on the other side of the bush and to finish the installation by pulling the sheet into its place by way of the strings. At this point it is desirable to close the edges of the sheet by way of hook and loop fasteners, for example. This closure will prevent the sheet being disturbed by sudden wind gusts or from the air that is discharged from a lawn mower.

### BRIEF DESCRIPTION OF THE DRAWINGS

FIG. 1 is a top view of the sheet showing the slit closed;

FIG. 2 is a top view of the sheet showing the slit in its open state;

FIG. 3 is a top view of the sheet showing details of the sheet.

### DETAILED DESCRIPTION OF THE INVENTION

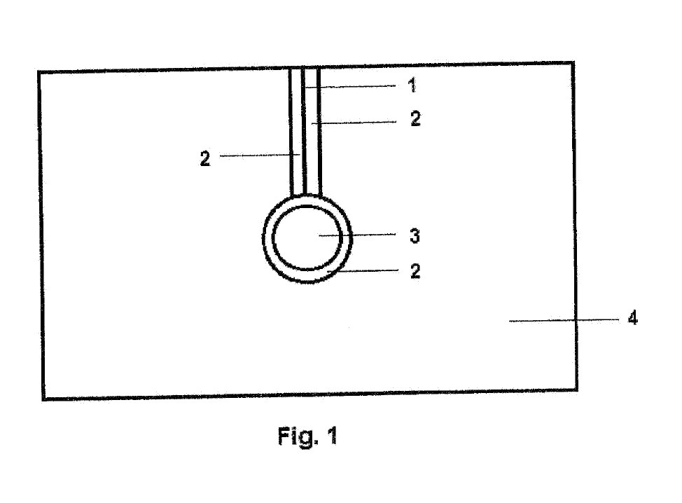

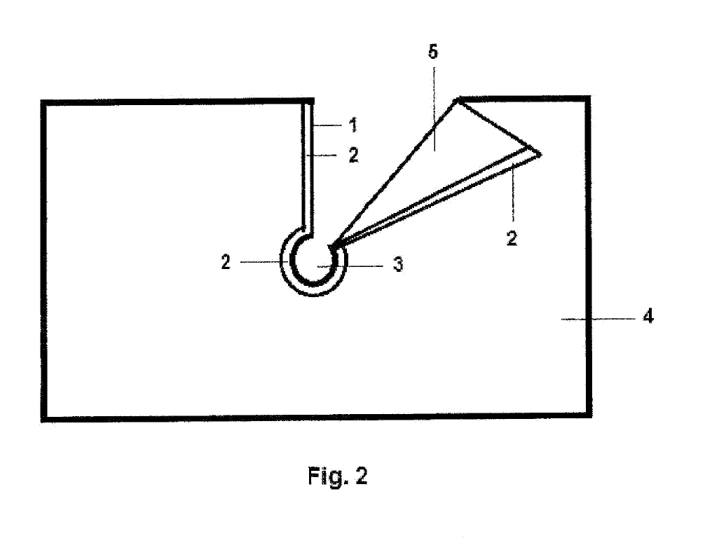

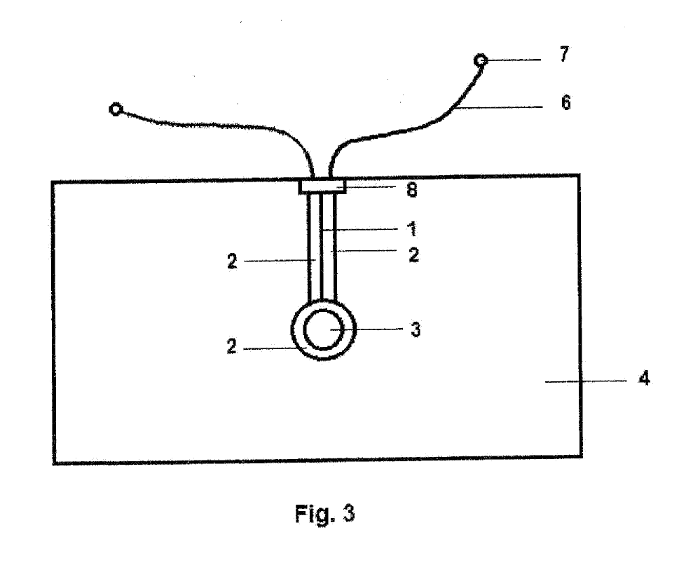

FIG. 1 illustrates the inventive concept in a rectangular sheet 4. The sheet can be configured to be rectangular, square or circular. The material of the sheet should be somewhat stiff, yet remain somewhat flexible, so that when it is placed in its intended location it will remain in place even in bad weather conditions or resisting marauding animals. The material could be made of heavy plastic material or canvas. It could also be made of a net-like material. FIG. 1 also shows a slit 1 which is cut into the sheet from one of the edges into the center of the sheet. The slit ends in the center of the sheet in a contoured opening. The contoured opening is intended to surround the trunk of the bush once the sheet is installed. The border or tape is applied to easily identify the opening when the sheet is filled with trimmings. It is also important that the edges of the slit be protected from fraying or cutting. Fraying could be caused by any obstacles in the ground where the bush is located. These obstacles could be part of roots sticking up from the ground, or rose bush thorns, or could be caused simply by rough handling. The protection in both FIGS. 1 and 2 can be seen as a border or tape 2 surrounding the edge of the slit including the straight cut 1 and the contoured opening 3. The well known duct tape would easily solve this purpose because it will easily adhere to the surfaces in front and back of the sheet. There are times when it is difficult to install the sheet under a bush because the branches are too close to the ground or the total circumference of the branches do not allow easy access to install the sheet. For this purpose, as shown in FIG. 3 an aid has been added to the sheet to make it easier to place the sheet in its proper attitude and position. FIG. 3 shows the addition of two strings 6 which are attached at each edge opening of the slit 1. The other or remote ends of the strings receive a weight 7. These weights 7 can be rocks found or present in the vicinity of the bush to be trimmed. These weights can be anything available such as pieces of metal or even plastic. The reason for adding this installation aid is, as mentioned above, because of the location of the bush to be trimmed being too close to the ground or having a large circumference or both.

The person doing the trimming would simply stand on one side of the bush and take one weight and throw it out under the bush just passed the trunk of the bush to the other side of the bush. The other weighted string is also thrown out under the bush passed the other side of the trunk. Thereafter, the person simply has to walk to other side of the bush and grab both ends of the weighted strings and pull the sheet under the bush into its proper place and finish the installation by closing the ends of the slit to stabilize the sheet.

What I claim is:

1. A system for catching trimmings when trimming a bush, said system including a sheet of material, said sheet having a cut therein extending toward the center of said sheet, said slit forming a circle at said center, the edges of said cut including said circle are surrounded by a tape, said tape adhering to both surfaces of said sheet.

2. The system of claim 1, including means for closing said cut at said edge of said sheet.

3. The system of claim 2, wherein said means for closing is a hook and loop fastening system.

4. The system of claim 1, including means for aiding and installation of said sheet under said bush.

5. The system of claim 4, wherein said means for aiding consists of strings attached to each front corner of said cut including weights attached to free ends of said strings.
